(19) United States
(12) Patent Application Publication
(10) Pub. No.: US 2011/0283612 A1
(43) Pub. Date: Nov. 24, 2011

(54) APPARATUS AND SYSTEM FOR PLANT CULTIVATION

(75) Inventors: Kwok-Kei Law, Hong Kong (CN); Sau Kin Selin Lee, Hong Kong (CN)

(73) Assignee: Law, Kwok-Kei, Hong Kong (CN)

(21) Appl. No.: 13/147,705

(22) PCT Filed: Feb. 8, 2010
(86) PCT No.: PCT/IB10/00237

§ 371 Date: Aug. 3, 2011

(30) Foreign Application Priority Data
Feb. 9, 2009 (HK) 09101155.0

(51) Int. Cl. A01G 31/02

(52) U.S. Cl. 47/60

(57) ABSTRACT

A plant cultivating apparatus comprises a base, a peripheral wall surrounding the base to define a cultivating volume or cultivating reservoir for plant cultivation, and connecting means for connecting the peripheral wall of the apparatus to the peripheral wall of an adjacent cultivating apparatus. This apparatus provides a green roof solution by a relatively simple arrangement.

### FIELD OF THE INVENTION

This invention relates to apparatus and system for cultivating plant, such as a plant cultivation apparatus, and particularly, this invention relates to roof-top plant cultivating apparatus for cultivating plants on the rooftop of high-rise buildings.

### BACKGROUND OF THE INVENTION

Green roof, which comes with various advantages, has become a trend in many modern cities. However, it is difficult to maintain relevant facilities including watering and drainage facilities due to the relatively limited space available, particularly on the rooftop of high-rise buildings. Existing apparatuses, for example those described in CN2850252Y and CN200969781Y, are relatively complex, and difficult to be installed and connected together if several of these apparatuses are to be used at the same site.

### OBJECTS OF THE INVENTION

Therefore, it is an object of this invention to resolve at least one or more of the problems as set forth in the prior art. Particularly, it is an object of the current invention to provide apparatus and system for cultivating plant that are relatively simple in structure, and relatively easy to be installed and connected together. As a minimum, it is an object of this invention to provide the public with a useful choice.

### SUMMARY OF THE INVENTION

According to the present invention, there is provided a plant cultivating apparatus comprising a base, a peripheral wall surrounding the base to define a cultivating volume or cultivating reservoir for plant cultivation, and connecting means for connecting the peripheral wall of the apparatus to the peripheral wall of an adjacent cultivating apparatus; wherein at least one water inlet and at least one water outlet are formed on the peripheral wall, and wherein the connecting means also defines a channel through which the cultivating volumes or the cultivating reservoirs of the connected apparatus are communicable.

This apparatus is advantageous because it provides a green roof solution by a relatively simple arrangement. For example, the apparatus could be assembled on site at roof top and configured to maximally follow the shape of the site, the modular nature of the apparatus makes it easier to transport to the roof top in limited space within a building, and watering could be made easier due to drain holes or water distribution holes interconnecting adjacent apparatus. The water distribution holes provides a easy irrigating means since water introduced into a first apparatus could flow into another one through the interconnected water distribution holes. With such an apparatus, a relatively large area could be covered by an assembly of plant cultivation apparatus within a short time.

The water outlet may also an overflow outlet located at a height above the base. The overflow arrangement enables water to flow and spread to other apparatus automatically without extra energy requirements.

The apparatus may further comprise a draining outlet on the peripheral wall for draining excessive water. Such draining hole could also be used as a second water outlet for spreading water to another interconnected apparatus.

The connecting means may comprise a slidable gate which is moveable relative to the water outlet to change the aperture size of the water outlet.

The peripheral wall may surround a plurality of mutually communicable cultivating cells, and each cultivating cell may comprise a cell peripheral wall on which at least one water inlet and at least one water outlet are formed, and at least one connecting means for connecting adjacent cultivating cells; and wherein the connecting means also defines a channel through which the cultivating volumes or cultivating reservoirs of the connected cultivating cells are communicable. This configuration, which provides a substantially modular approach of construction by using an individual cell as a construction unit, enables an ensemble of apparatus to be provided to suit different space requirements

Accordingly, this invention also provides an apparatus for cultivating plant including a base being connected to a plurality of walls. The base and the plurality of walls define a space for reserving water. At least one first opening on one of said plurality of walls, and the one first opening is shaped to receive a connecting member for connecting to another plant cultivating apparatus of this invention. Water reserved in the space enters or leaves the plant cultivating apparatus through the connecting member.

Preferably, the at least one first opening is formed on said one of the plurality of walls.

Alternatively, said at least one connecting member is separable from the plurality of walls.

Advantageously, plant cultivating apparatus of this invention includes a porous support having a plurality of pores and being maintained at a desired distance from said base. More preferably, the at least one first opening is positioned at a first predetermined distance from the base, and said desired distance is substantially the same as said first predetermined distance. Additionally, the plant cultivating apparatus of the current invention includes at least one second opening for draining excessive water from said apparatus, and the at least one second opening is positioned at a second predetermined distance from the base, and the second predetermined distance is longer than the first predetermined distance. Alternatively, the desired distance is adjustable.

Preferably, the base has a shape selected from the group consisting of square, rectangle, triangle, and hexagon.

Optionally, the at least one connecting member and the at least one first opening form a seal. More preferably, the plant cultivating apparatus of this invention further includes a sealing sleeve for forming the seal.

It is another aspect of this invention to provide a plant cultivating apparatus including a base being connected to a plurality of walls, the base and the plurality of walls defining a space for reserving water. At least one connecting member separable from one of said plurality of walls is provided for connecting the plant cultivating apparatus to another said plant cultivating apparatus. The at least one first opening is formed on said at least one connecting member, wherein water reserved in said space enters or leaves the plant cultivating apparatus through said at least one first opening.

It is another aspect of the current invention to provide a system for cultivating plant including a plurality of the above apparatus interconnecting to each other.

### BRIEF DESCRIPTION OF THE DRAWINGS

Preferred embodiments of the present invention will now be explained by way of example and with reference to the accompanying drawings in which:

FIG. 1 shows four of an exemplary apparatus of the current invention adapted to be connected to each other to form a plant cultivation system by a connecting member;

FIG. 2 shows the plant cultivation system with another connecting member, and provided with a porous support.

FIG. 3 shows the exploded view of another exemplary apparatus of the current invention;

FIG. 4 shows the installation of several apparatuses of FIG. 3 to form another plant cultivation system; and

FIG. 5 shows yet another exemplary apparatus of the current invention.

### DETAILED DESCRIPTION OF THE PREFERRED EMBODIMENTS

This invention is now described by way of example with reference to the figures in the following paragraphs. List 1 below is a part list so that the reference numerals in the figures may be easily referred to.

List 1

| Reference | |
|---|---|
| Numerals | Description |
| 10, 110 | Cultivating apparatus |
| 12, 112 | Base |
| 14, 114 | Wall |
| 16, 116 | First opening |
| 18, 18a, 118 | Connecting member |
| 20, 120 | Porous support |
| 19 | Sealing sleeve |
| 117 | Second opening |

Objects, features, and aspects of the present invention are disclosed in or are apparent from the following description. It is to be understood by one of ordinary skilled in the art that the present discussion is a description of exemplary embodiments only, and is not intended as limiting the broader aspects of the present invention, which broader aspects are embodied in the exemplary constructions.

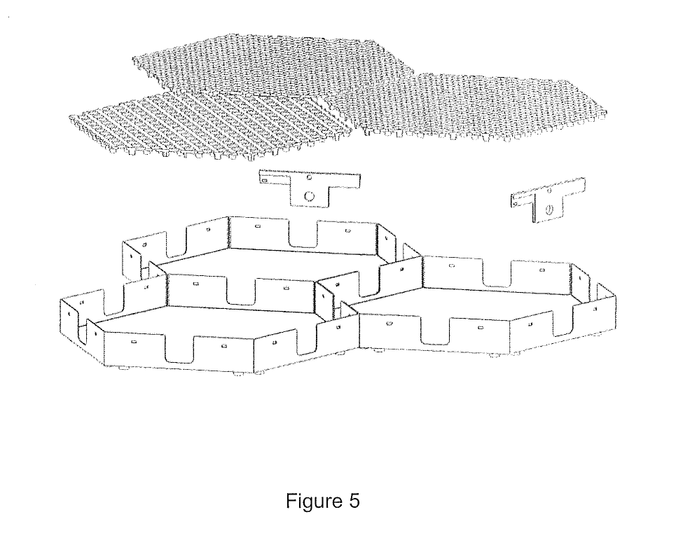

Exemplary plant cultivating apparatus and system of the current invention are shown in FIGS. 1 to 5. As shown in FIG. 1, the plant cultivating apparatus 10 of the current invention is formed by a base 12 connected to a plurality of walls 14, which define a space for reserving water. The base can be of any shape including square, rectangle, triangle, and hexagon, and the number of walls connected to the base will depend on the shape of the base. FIG. 5 shows a hexagonally shaped plant cultivating apparatus of the current invention.

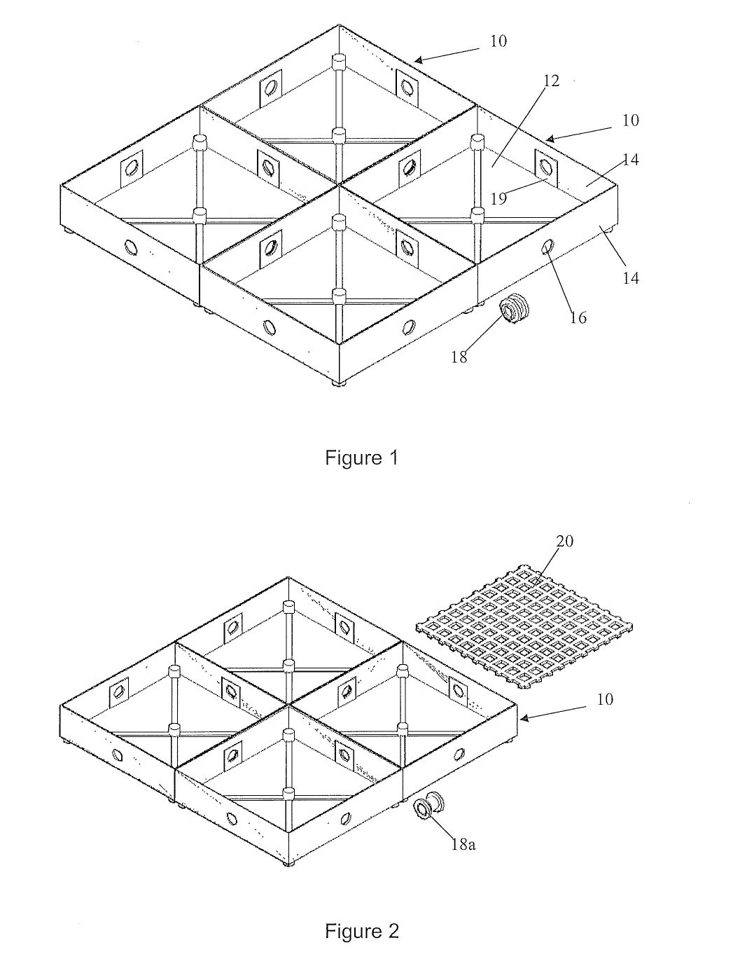

In FIGS. 1 and 2, on the wall 14, there is provided a first opening 16 shaped to receive a connecting member 18 for connecting to another plant cultivating apparatus 10. For example, if the connecting member 18 is in a tubular shape as shown in FIGS. 1 and 2, the first opening should then be in a circular shape. In the Figures, the connecting member 18,118 is separable from the walls 14,114. Water reserved in the space defined by the base 12 and the walls 14 enters or leaves the space through the connecting member 18. This first opening 16 is To facilitate the flow of the reserved water among the plant cultivating apparatus 10, it is preferred that the first opening 16 and the connecting member 18 form a seal, for example by making a first opening 16 with an appropriate size to fit with the connecting member 18 and/or providing a sealing sleeve 19 such that the first opening 16 and the connecting member 18 form a seal. Other appropriate sealing mechanisms can also be used.

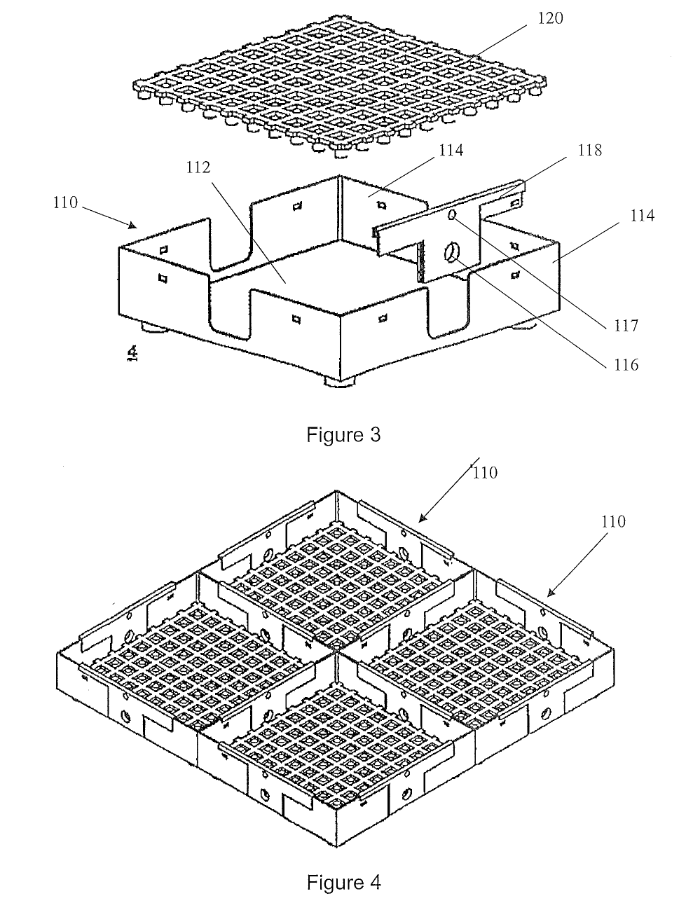

A porous support 20,120 is optionally provided and maintained at a desired distance from the base. In FIG. 2, the porous support 20 is maintained by a plurality of protrusions formed on the base 12. In the exemplary apparatus of FIG. 3, the porous support 120 has a plurality of protrusions, which maintain the porous support 120 at the desired distance from the base 112. The porous support 20,120 could be maintained at the desired distance by many other methods, for example by recesses or rails on the walls 14,114 of the base and fitting a suitably sized porous support 20,120 into the recesses or rails. Soil for cultivating the plant could be placed on top of the porous support 20,120, and water reserved in the space defined by the desired distance between the porous support 20, 120 and the base 12, 112. The desired distance is chosen such that the soil is dampened to a suitable degree, which depends on the plant to be cultivated. As such, it is preferred that the desired distance is adjustable. This can be accomplished by various different methods, for example, by adjusting the height or thickness of the protrusions of the exemplary apparatus in FIG. 1, or by providing several recesses or rails on the walls 14,114 at different levels.

Additionally, the first opening 16,116 is positioned at a first predetermined distance from the base, which is preferred to be about the same as the desired distance (from which the porous support 20,120 is separated from the base). This would allow the control of dampening of the soil more effectively by allowing excess water to leave the apparatus 10,110 automatically when the water level is above the porous support 20,120. The plant cultivating apparatus 10,110 may also include at least one second opening (as shown in FIGS. 3 to 5) positioned above the base at a higher position than the first opening, such that excessive water, for example resulted from rain, can be drained from the plan cultivating apparatus 10,110.

In one alternative embodiment of the current invention, the first opening 116 is formed on the connecting member 118. In the particular example shown in FIGS. 3 and 4, both of the first opening 116 and the second opening 117 are formed on the connecting member 118. In this embodiment, the first opening 116 is no longer required to be shaped to receive the connecting member 118. Instead, the connecting member 118 can be in various suitable forms as long as it can connect two the plant cultivating apparatuses 110 together. For example, the connecting member 118 in FIG. 3 is in the form of a generally T-shaped clamp to be inserted into a complimentary U-shaped trough on one wall of the plant cultivating apparatus 110. The connecting member 118 can be in various other forms, for example, in the form of clamping member for connecting the plant cultivating apparatus 110. Further, additional engagement mechanisms may be provided to further secure the connection between the plant cultivating apparatus 110, for example protrusions and complimentary indentations on the connecting member 118 and the wall 114, or orifices on the connecting member 118 and the wall for tying. Alternatively, the connecting member 118 can be separable (as shown in FIG. 3) or can be integrated with the plant cultivating apparatus 110. In the later case, the trough on the wall of the plant cultivating apparatus 110 may no longer be necessary but may be replaced by other engagement mechanisms complimentary to the connecting member 118. However, separable connecting members 118 have the advantages of ease of replacement and maintenance.

The T-shaped separable connecting clamp as shown in FIG. 3, which can be inserted vertically (or in any direction that has a vertical component) into the trough of the wall of the plant cultivating apparatus 110 may have the advantage of allowing tight connection between various the plant cultivating apparatuses 110, and reducing leakage. However, the embodiments shown in FIGS. 3 and 4 are structurally more complex that those in FIGS. 1 and 2.

Optionally, the height of the base 12,112 (relatively to the ground) is also adjustable. Some possible adjustment mechanisms have been described above.

The plant cultivating apparatus 10,110 of the current invention is relatively simple and with low manufacturing costs. In some embodiments, the flexibility of allowing different levels of dampening of the soil is provided by allowing adjustment of the distance of the porous support 20,120 from the base 12,112. Further, the connecting members 18,118 allow a number of the plant cultivating apparatus of the current invention to be connected together relatively easily while maintaining the drainage function among the apparatus. This allows only one plant cultivating apparatus of the current invention to be filled with water and all of the interconnected apparatuses can be watered simultaneously.
1. While the preferred embodiment of the present invention has been described in detail by the examples, it is apparent that modifications and adaptations of the present invention will occur to those skilled in the art. Furthermore, the embodiments of the present invention shall not be interpreted to be restricted by the examples or figures only. It is to be expressly understood, however, that such modifications and adaptations are within the scope of the present invention, as set forth in the following claims. For instance, features illustrated or described as part of one embodiment can be used on another embodiment to yield a still further embodiment. Thus, it is intended that the present invention cover such modifications and variations as come within the scope of the claims and their equivalents.

1-19. (canceled)

20. A plant cultivating apparatus comprising a base, a peripheral wall surrounding the base to define a cultivating cell, each cultivation cell defining a cultivating volume or cultivating reservoir for plant cultivation, and connecting means for connecting the peripheral wall of the apparatus to the peripheral wall of an adjacent cultivating apparatus; wherein at least one water inlet and at least one water outlet are formed on the peripheral wall, and wherein the connecting means also defines a channel through which the cultivating volumes or the cultivating reservoirs of adjacently connected apparatus are communicable through the connecting means.

21. A plant cultivating apparatus according to claim 20, wherein the water outlet is also an overflow outlet located at a height above the base.

22. A plant cultivating apparatus according to claim 20, wherein the connecting means comprises a slidable gate which is moveable relative to the water outlet to change the aperture size of the water outlet.

23. A plant cultivating apparatus according to claim 22, wherein the peripheral wall is divided into a plurality of walls, and the plurality of walls defines a polygon, including a rectangle, a pentagon, and a hexagon.

24. A plant cultivating apparatus according to claim 23, wherein the peripheral wall surrounds a plurality of mutually communicable cultivating cells, and each cultivating cell comprises a cell peripheral wall on which at least one water inlet and at least one water outlet are formed, the at least one water outlet being an overflow outlet located at a height above the base; and at least one connecting means for connecting adjacent cultivating cells; and wherein the connecting means also defines a channel through which the cultivating volumes or cultivating reservoirs of the connected cultivating cells are communicable.

25. A plant cultivating apparatus according to claim 20, wherein the peripheral wall surrounds a plurality of mutually communicable cultivating cells, and each cultivating cell comprises a cell peripheral wall on which at least one water inlet and at least one water outlet are formed, the at least one water outlet being an overflow outlet located at a height above the base; and at least one connecting means for connecting adjacent cultivating cells; and wherein the connecting means also defines a channel through which the cultivating volumes or cultivating reservoirs of the connected cultivating cells are communicable.

26. A plant cultivating apparatus according to claim 20, wherein a water inlet of one cultivating cell is connected to the water outlet of another cultivating cell via the connecting means, the water inlet and outlets being connected such that water is distributed between the adjacently connected cultivating cells.

27. A plant cultivating apparatus, including:
i. a base connected to a plurality of walls, the base and the plurality of walls defining a space for reserving water;
ii. at least one first opening on one of said plurality of walls, said at least one first opening being shaped to receive a connecting member for connecting to another said plant cultivating apparatus, wherein water reserved in said space enters or leaves the plant cultivating apparatus through the connecting member;
wherein the at least one first opening is formed on said one of the plurality of walls.

28. A plant cultivating apparatus of claim 27, wherein the at least one connected member is separable from the plurality of walls.

29. A plant cultivating apparatus of claim 28, wherein the at least one connecting member is separable from the plurality of walls.

30. A plant cultivating apparatus of claim 27 further including a porous support having a plurality of pores and being maintained at a predetermined height from said base; wherein the at least one first opening is also at the predetermined height.

31. A plant cultivating apparatus of claim 30, further including at least one second opening for draining excessive water from said apparatus, said at least one second opening being positioned at a second predetermined height from the base, and the second predetermined height is higher than the first predetermined height.

32. A plant cultivating apparatus of any one of claim 31, wherein said desired height is adjustable.

33. A plant cultivating apparatus of claim 27, wherein said at least one connecting member and said at least one first opening form a seal.

34. A plant cultivating apparatus of claim 33 further including a sealing sleeve for forming said seal.

35. A plant cultivating apparatus, including:
iii. a base being connected to a plurality of walls, the base and the plurality of walls defining a space for reserving water;
iv. at least one connecting member separable from one of said plurality of walls, said at least one connecting member for connecting the plant cultivating apparatus to another said plant cultivating apparatus, wherein at least one first opening is formed on said at least one connecting member, wherein water reserved in said space enters or leaves the plant cultivating apparatus through said at least one first opening.

36. A system for cultivating plant including a plurality of the apparatuses of claim 35 in interconnection.
